(19) United States
(12) Patent Application Publication
(10) Pub. No.: US 2010/0085637 A1
(43) Pub. Date: Apr. 8, 2010

(54) DIFFERENTIAL INTERFERENCE CONTRAST MICROSCOPE

(75) Inventors: DING-KUN LIU, Hsinchu County (TW); FU-SHIANG YANG, Hsinchu County (TW); CHUN-CHIEH WANG, Taoyuan County (TW)

Correspondence Address: WPAT, PC;INTELLECTUAL PROPERTY ATTORNEYS, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 12/360,504

(22) Filed: Jan. 27, 2009

(30) Foreign Application Priority Data
Oct. 3, 2008 (TW) 097138242

(51) Int. Cl. G02B 21/06; G02B 21/14

(52) U.S. Cl. 359/386; 359/371

(57) ABSTRACT

A differential interference contrast microscope (DIC microscope) suitable for inspecting a specimen inside a measurement area comprises a light source, a beam splitter, a first and second polarizer, a first and second DIC prism, a wave plate, and an image sensor, wherein the beam splitter reflects the beam generated from the light source to the measurement area, and the beam be reflected from the measurement area passes through the beam splitter to the image sensor. The first polarizer is located between the light source and the beam splitter, and the second polarizer is located between the beam splitter and the image sensor. The first DIC prism, the wave-plate and the second DIC prism are located between the beam splitter and the measurement area in order. The included angle between the principal axis of the first DIC prism and the principal axis of the second DIC prism is 90 degree.

### FIELD OF THE INVENTION

The present invention relates to a microscope, and more particularly, to a differential interference contract (DIC) microscope.

### BACKGROUND OF THE INVENTION

Currently, most common manufacturing process for fabricating thin film transistor (TFT) display device includes a step of forming thin film transistors on a transparent glass substrate while inspecting the same by the use of a differential interference contrast (DIC) means.

Please refer to FIG. 1A, which shows a conventional differential interference contrast microscope disclosed in U.S. Pat. No. 6,034,814. In FIG. 1A, the conventional differential interference contrast (DIC) microscope 100, being the device commonly employed to observe microscopic detail in a specimen 50, is comprised of a light source 110, a first polarizer 120, a beam splitter 130, a DIC prism 140, a second polarizer 150 and an image sensor 160, in which a light beam 112 emitted from the light source 110 is directed to impinge on the beam splitter for reflecting the same toward the specimen 50 where it is further being reflected back to the light splitter 130 and continues to travel pass the light splitter 130 to shine on the image sensor 160. In addition, for enhancing imaging quality, it is commonly seem in those conventional DIC microscopes to have a plurality of lenses 170 arranged on the optical path of the light beam 112. Moreover, the DIC prism 140 in FIG. 1A is composed of two biaxial crystals made of different materials which is configured for enabling any one optical axis of one of two biaxial crystals to align with any optical axis of another biaxial crystal. Thereby, the light beam 112 entering the DIC prism 140 will be separated into two beams 112a and 112b departing by a specific optical path difference that are directed to travel toward the specimen 50. Then, the two beams 112a, 112b will be reflected by the specimen 50 and travel back to the DIC prism 140 where they are combined into one beam 112c, and then the beam 112c including the interference fringes of the two beams 112a, 112c are directed to the image sensor 160 for analysis. Although the beams 112a and 112b appear to be separated from each other as those shown in FIG. 1A, actually they are almost traveling as one beam and thus illuminate the specimen 50 at about the same position.

FIG. 1B shows a specimen being observed by the DIC microscope of FIG. 1A, and FIG. 1C is a schematic diagram showing an observation of the specimen of FIG. 1B from the DIC microscope of FIG. 1A. In FIG. 1B, there is apparently a rectangle block structure on the surface of the specimen 50. In FIG. 1C, since the features of different contrasts in the image of the DIC microscope which are oriented perpendicular to the resolution axis X can be clearly identified and those parallel thereto can not, the two longitudinal sides of the rectangle block can be clearly recognized while two end sides of the rectangle block can not. Hence, the resolution axis X is the principle axis of the DIC prism 140. In another word, in any single operation, the analysis of the DIC microscope is limited by its DIC prism 140 to a specific axial direction perpendicular to its resolution axis that it is not applicable to those parallel to the resolution axis.

Please refer to FIG. 2, which shows another conventional differential interference contrast microscope disclosed in U.S. Pat. No. 6,433,876. In FIG. 2, the conventional differential interference contrast (DIC) microscope 200, also being the device commonly employed to observe microscopic details in a specimen 50, is configured with two interference systems for obtaining interference data from two independent resolution axes. The DIC microscope 200 comprises a first light source 210, a first DIC prism 220, a first image sensor 230, a second light source 240, a second DIC prism 250, a second image sensor 26, a plurality of beam splitters 270 and a control unit 280, in which the assembly of the first light source 210, the first DIC prism 220 and the first image sensor 230 constructs the first interference system while the assembly of the second light source 240, the second DIC prism 250 and the second image sensor 260 constructs the second interference system. The resolution axes of DIC prisms 220, 250 in the first and the second interference systems are mutually orthogonal to each other so that the portion of the image that is not analyzable by the first image sensor 230 can be detected by the second image sensor 260, and vice versa. Therefore, by the connection between the first and the second image sensors 230, 260 enabled by the control unit 280, images of the two interference systems can be stacked for compensating each with their corresponding undetectable portions so that the complete microscopic detail of the specimen 50 can be detected.

Please refer to FIG. 3, which shows yet another conventional differential interference contrast microscope disclosed in Thin Solid Films, Vol. 462-463 (2004), pp. 257-262. The DIC microscope 300 shown in FIG. 3 is structured similar to the DIC microscope 100 of FIG. 1A, except that the DIC microscope 300 is further comprised of: a first quarter-wave plate 380 and a second quarter-wave plate 390; and is structured for enabling the DIC prism 140 to rotate so as to adjust the orientation of its principle axis. In detail. The first quarter-wave plate 380 and the second quarter-wave plate 390 are located on the optical path of the light beam 112 at positions that the first quarter-wave plate 380 is disposed between the first polarizer 120 and the light splitter 130 while the second quarter-wave plate 390 is disposed between the light splitter 130 and the second polarizer 150. As shown in FIG. 3, the principle axis of the first quarter-wave plate 380 forms an angle of 45 degrees with the first polarizer 120, by which the light beam 120 is circularly polarized to impinge the DIC prism 140. As the DIC prism 140 is designed to be rotatable for adjusting the orientation of its principle axis, two mutually compensated images can be obtained corresponding to two independent resolution axes of the DIC prism 40 that are mutually orthogonal to each other. Thus, the so-obtained two images can be stacked for compensating each with their corresponding undetectable portions so that the complete microscopic detail of the specimen 50 can be detected.

### SUMMARY OF THE INVENTION

In an embodiment, the present invention provides a DIC microscope which comprises: a light source, a beam splitter, an image sensor, a first polarizer, a second polarizer, a first DIC prism, a wave plate and a second DIC prism, wherein the beam splitter reflects a beam generated from the light source to a measurement area, and then the beam be reflected from the measurement area passes through the beam splitter to the image sensor, while the first polarizer, the second polarizer, the first DIC prism, the wave-plate and the second DIC prism are disposed on the optical path of the beam in a manner that the first polarizer is located between the light source and the beam splitter, the second polarizer is located between the beam splitter and the image sensor, the first DIC prism is located between the beam splitter and a specimen, the wave-plate is located between the first DIC prism and the measurement area, and the second DIC prism is located between the wave plate and the measurement area; and the included angle between the principal axis of the first DIC prism and the principal axis of the second DIC prism is 90 degrees.

In another exemplary embodiment, the present invention provides a DIC microscope suitable for inspecting a specimen inside a measurement area, which comprises: a light source, an image sensor, a first polarizer, a first DIC prism, a first wave plate, a second DIC prism, a third prism, a second wave plate, a fourth DIC prism and a second polarizer, wherein a beam generated from the light source is directed to travel passing the measurement area and thus enter the image sensor, while the first polarizer, the first DIC prism, the first wave-plate, the second DIC prism, the third DIC prism, the second wave plate, the fourth DIC prism and the second polarizer are disposed on the optical path of the beam in a manner that the first polarizer is located between the light source and the measurement, the first DIC prism is located between the first polarizer and the measurement area, the first wave-plate is located between the first DIC prism and the measurement area, the second DIC prism is located between the first wave plate and the measurement area, the third DIC prism is located between the measurement area and the image sensor, the second wave plate is located between the third DIC prism and the image sensor, the fourth DIC prism is located between the second wave plate and the image sensor, and the second polarizer is located between the fourth DIC prism and the image sensor; and the principle axis of the first DIC prism is orientated the same as that of the fourth DIC prism and the principle axis of the third DIC prism is orientated the same as that of the second DIC prism, while the included angle between the principal axis of the first DIC prism and the principal axis of the second DIC prism is 90 degrees.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1A shows a conventional differential interference contrast microscope.

FIG. 1B shows a specimen being observed by the DIC microscope of FIG. 1A

FIG. 1C is a schematic diagram showing an observation of the specimen of FIG. 1B from the DIC microscope of FIG. 1A.

FIG. 2 shows another conventional differential interference contrast microscope.

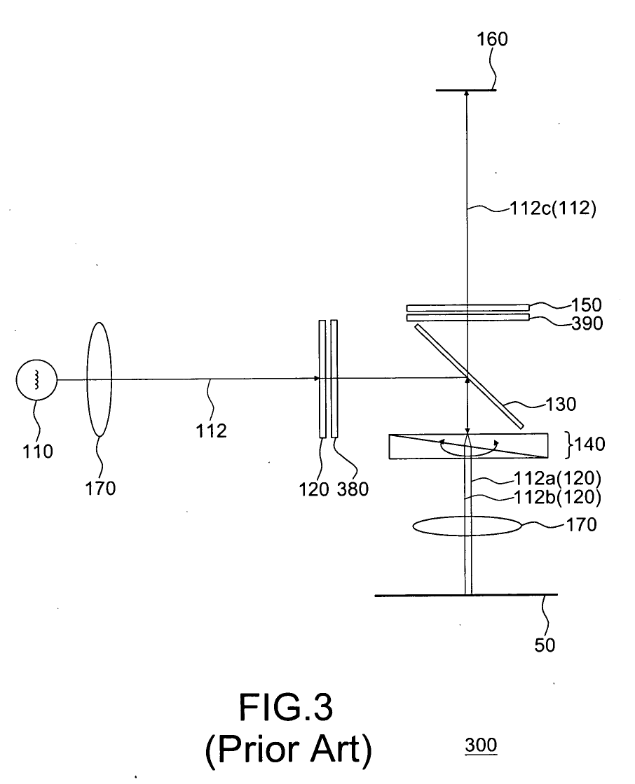

FIG. 3 shows yet another conventional differential interference contrast microscope.

FIG. 4A shows a differential interference contrast microscope according to an embodiment of the invention.

FIG. 4B is a schematic diagram showing an observation of the specimen of FIG. 1B from the DIC microscope of FIG. 4A.

FIG. 4C˜FIG. 4E are actual images respectively obtained by the use of a conventional DIC microscope, the DIC microscope of FIG. 4A cooperating with a quarter-wave plate, and the DIC microscope of FIG. 4A cooperating with a half-wave plate.

FIG. 5A shows a differential interference contrast microscope according to another embodiment of the invention.

FIG. 5B and FIG. 5C are schematic diagrams showing how the beam in FIG. 5A is polarized as it travels passing different components.

### DESCRIPTION OF THE EXEMPLARY EMBODIMENTS

The present invention relates to a differential interference contrast (DIC) microscope, capable of obtaining an image containing two information detected with respect to two mutually orthogonal resolution axes simultaneously for completing an inspection in an automatic and rapid manner.

Moreover, the present invention also relates to a DIC microscope with comparatively simple structure that not only can be assembled easily, but also can be fabricated with comparatively less cost.

For your esteemed members of reviewing committee to further understand and recognize the fulfilled functions and structural characteristics of the invention, several exemplary embodiments cooperating with detailed description are presented as the follows.

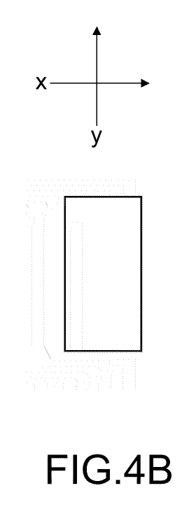

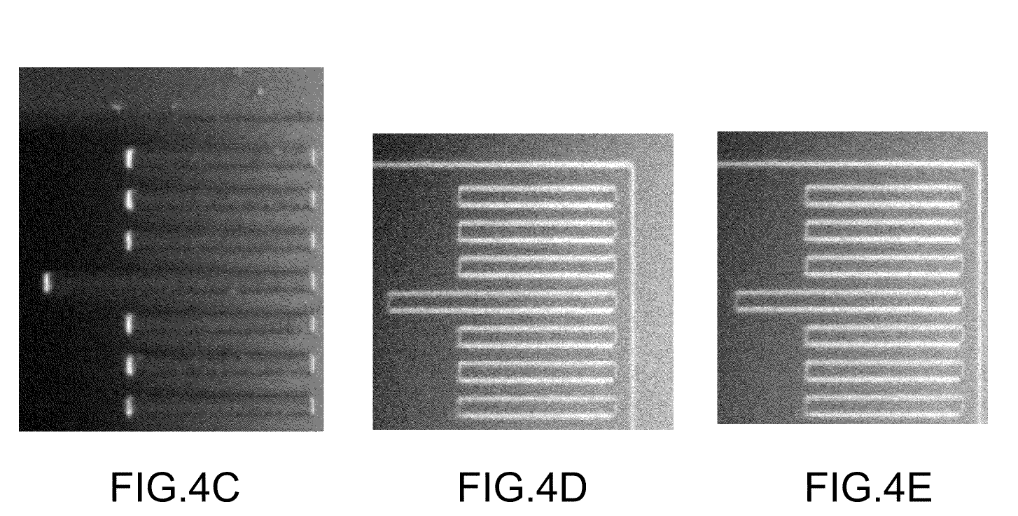

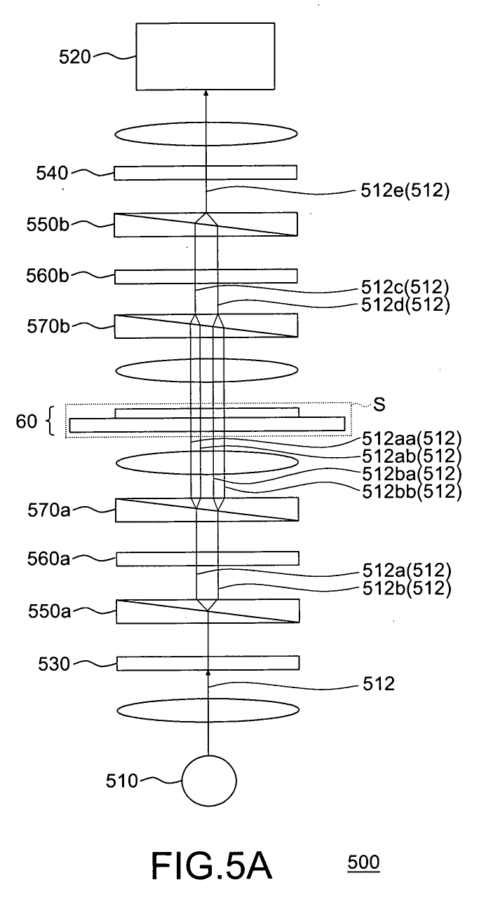

Please refer to FIG. 4A, which shows a differential interference contrast microscope according to an embodiment of the invention. The differential interference contrast microscope 400 of FIG. 4A is structured as a reflection system, which is adapted for detecting defects on a specimen 50, such as a silicon substrate used in semiconductor fabrication process, or a glass substrate, etc., but is not limited thereby.

In this embodiment, a measurement area S is designed in the differential interference contrast microscope 400 for placing the specimen 50. For clarity, the description of the invention hereinafter will focus on the specimen 50, but for those skilled in the art that those descriptions relating to the specimen 50 can also apply to the measurement area S.

The differential interference contrast microscope 400 includes a light source 410, a beam splitter 420, an image sensor 430, a first polarizer 440, a second polarizer 450, a first DIC prism 460, a wave plate 470 and a second DIC prism 480, in which the beam splitter 420 reflects a beam 412 generated from the light source 410 to the specimen 50, and then the beam 412 be reflected from the specimen 50 passes through the beam splitter 420 to the image sensor 430, while the first polarizer 440, the second polarizer 450, the first DIC prism 460, the wave-plate 470 and the second DIC prism 480 are disposed on the optical path of the beam 412.

In detail, the first polarizer 440 is located between the light source 410 and the beam splitter 420, the second polarizer 450 is located between the beam splitter 420 and the image sensor 430 while enabling the principle axes of the two polarizers 440, 450 to be mutually orthogonal, so that the two polarizers 440, 450 can be used as a polarizer and an analyzer in respective. Moreover, the first DIC prism 460, the wave plate 470 and the second DIC prism 480 are sequentially located between the beam splitter 420 and the specimen 50 in a manner that the first DIC prism 460 is positioned mostly close to the beam splitter 420 while enabling an included angle of 90 degrees to be formed between the principal axis of the first DIC prism 460 and the principal axis of the second DIC prism 480.

By the cooperation of the mutually orthogonal first DIC prism 460 and second DIC prism 480 and the use of the wave plate 470 for adjusting the polarization of the light beam 412, two information with respect to the two mutually orthogonal principle axes can be obtained simultaneously after the light beam 412 travels passing the first and the second DIC prisms 460, 480, and thus an image containing the two information can be formed in the image sensor 430 for inspecting the specimen 50.

Accordingly, the light beam 412 will split into two rays 412a, 412b departing by a specific optical path difference after it is reflected by the beam splitter 420 and travels passing the first DIC prism 460. Then, after the two rays 412a, 412b travel passing the second DIC prism 480, they are going to be split respectively into a pair of rays 412aa, 412ab, and another pair of rays 412ba, 412bb. Similarly, the optical paths of the two rays in the same pair are not the same, but are all being directed to the specimen 50. It is noted that since the principle axes of the first DIC prism 460 and the second DIC prism 480 are mutually orthogonal, the two rays 412aa, 412ab are appeared to be stacked and that is also true for the other two rays 412ba, 412bb. However, actually the four rays 412aa, 412ab, 412ba, 412bb are almost traveling as one beam and thus illuminate the specimen 50 at about the same position. In FIG. 4A, it is for emphasizing the interference so that the four rays 412aa, 412ab, 412ba, 412bb are depicted as they are separated.

As the specimen 50 will reflect the four rays 412aa, 412ab, 412ba, 412bb back to the second DIC prism 480 where the pair of rays 412aa, 412ab is converged into a ray 412a while the other pair of rays 412ba, 412bb is converged into another ray 412b, the ray 412a will contain the interference information relating to the two rays 412aa, 412ab and the ray 412b will contain the interference information relating to the two rays 412ba, 412bb, i.e. the two rays 412a, 412b respectively contains interference data from the resolution axis of the second DIC prism 480.

Thereafter, the two rays 412a, 412b traveling passing the second DIC prism 480 is converged into a ray 412c which contains interference information of the two rays 412a, 412b, i.e. the ray 412c contains interference data from the resolution axis of the first DIC prism 460. In another word, the ray 412c will contain not only the interference data from the resolution axis of the first DIC prism 460, but also the interference data from the resolution axis of the second DIC prism 480. Therefore, when the ray 412c impinges the image sensor 430, an image containing two interference information detected with respect to two mutually orthogonal resolution axes of the first and the second DIC prisms 460, 480 will be obtained simultaneously so that the specimen 50 can be inspected in a rapid manner.

By the used of the aforesaid DIC microscope 400, an image with complete information can be obtained without any numerical calculation, so that as the imaging speed is greatly improved, the efficiency for inspecting the specimen is enhanced for facilitating an automatic scanning process to be performed.

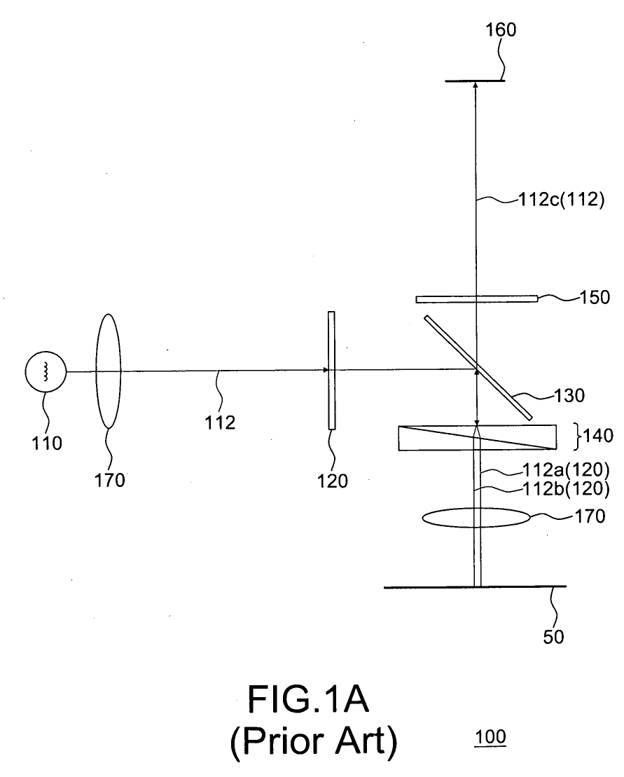

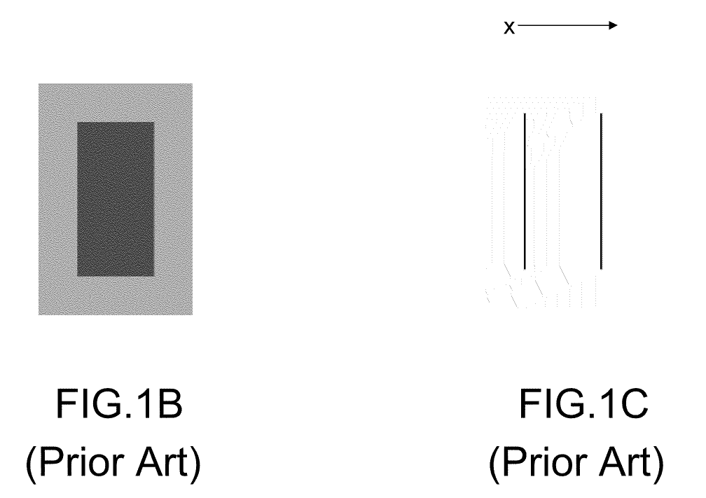

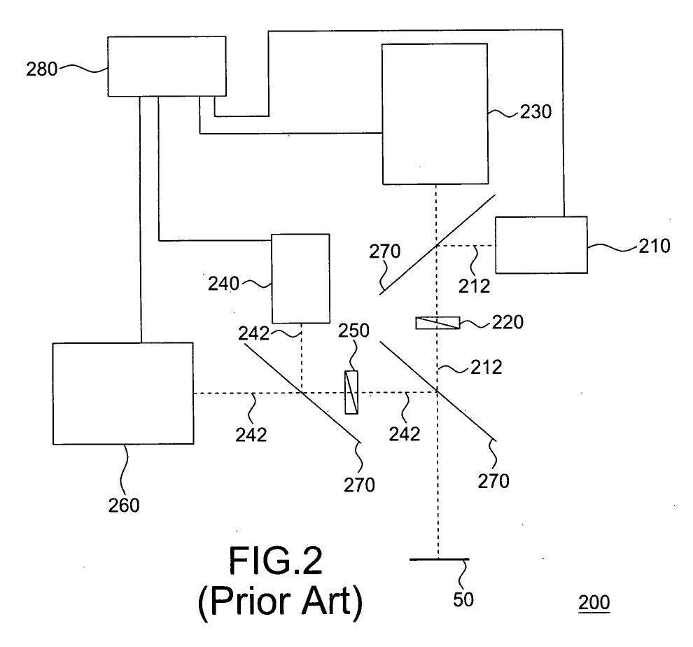

Comparing with the conventional DIC microscope 100 shown in FIG. 1A, the DIC microscope 400 of the invention is only added with the wave plate 470 and the second DIC prism 480 that there is no additional complex optical path design and no additional sophisticated rotation device. Thus, the DIC microscope 400 is comparatively simple in structure that not only can be assembled easily, but also can be fabricated with comparatively less cost.

It is noted that the principle axes of all the components in the DIC microscope of the invention are defined with respect to the light beam 412 that they are not defined by any coordinate system as it is known to those skilled in the art. Thereby, in the embodiment of the invention, the optical axis of the light beam 412 should first be defined so as to be used as base for calibrating the principle axes of all the components in the DIC microscope. In this embodiment, the principle axis of the first DIC prism 460 is aligned with the optical axis of the light beam 412, that is, the included angle between the principle axis of the first DIC prism 460 and the optical axis of the light beam 412 is zero degree. Thus, the adjusting of the included angles between the principle axes of the other components and the optical axis of the light beam 412 is equivalent to the adjusting of the included angles between the principle axes of the other components and the principle axis of the first DIC prism 460.

As there is an included angle of 90 degree formed between the principle axis of the first DIC prism 460 and that of the second DIC prism 480, the principle axis of the second DIC prism 480 is perpendicular to the optical axis of the light beam 412. Moreover, as there is an included angle of 45 degrees being formed between the principle axis of the first polarizer 440 and the optical axis of the light beam 412 and another included angle of 135 degrees formed between the principle axis of the second polarizer 450 and the optical axis of the light beam 412, the first polarizer 440 and the second polarizer 450 are designed to function respectively as a polarizer and an analyzer.

In addition, the wave plate 470 is used for adjusting the polarization of the light beam 412. In this embodiment, the wave plate 470 is a quarter-wave plate whose principle axis forms an included angle of 45 degrees with the optical axis of the light beam 412. However, in another embodiment, the wave plate 470 can be a half-wave plate, so that its principle axis should form an included angle of 22.5 degrees with the optical axis of the light beam 412.

Please refer to FIG. 4B, which is a schematic diagram showing an observation of the specimen of FIG. 1B from the DIC microscope of FIG. 4A. With reference to FIG. 1B and FIG. 1C, the profile of the rectangle block structure is clearly defined which indicated that information relating to two mutually orthogonal resolution axes, i.e. the X axis and Y axis, can be obtained simultaneously.

Please refer to FIG. 4C˜FIG. 4E, which are actual images respectively obtained by the use of a conventional DIC microscope, the DIC microscope of FIG. 4A cooperating with a quarter-wave plate, and the DIC microscope of FIG. 4A cooperating with a half-wave plate. In FIG. 4C, in any single operation, the analysis of the DIC microscope 100 is limited to only one axial direction perpendicular to its resolution axis that it is not able to identify the complete outlines of the multiple rectangle blocks but only the ends of each block. On the other hand, as shown in FIG. 4D and FIG. 4E, the complete outlines of those rectangle blocks are clearly identified since both can detect information relating to two mutually orthogonal resolution axes, so that they are capable of detecting any fabrication defect in the specimen 50.

It is noted that the aforesaid quarter-wave plate and half-wave plate are only for illustration as they are the most common wave plate available and thus the wave plate 470 of the invention is not limited thereby. It will be obvious that the type of the wave plate as well as the resulting included angle may be varied in many ways. Such variations are not to be regarded as a departure from the spirit and scope of the invention, and all such modifications as would be obvious to one skilled in the art are intended to be included within the scope of the following claims.

In the embodiment shown in FIG. 4A, for enhancing the collimation of light beam with respect to the focus accuracy, the DIC microscope 400 is further configured with a first lens 490a, a second lens 460b and a third lens 490c while locating those on the optical path of the light beam 412 in a manner that the first lens 490a is located between the light source 410 and the first polarizer 440, the second lens 490b is located between the specimen 50 and the second DIC prism 480, and the third lens 490c is located between the second polarizer 450 and the image sensor 430. It is noted that the configuration of the aforesaid lenses relating to their disposition and quantity is only for illustration and thus is not limited thereby. In addition, the image sensor 430 in the DIC microscope of the invention can be a charge coupled device (CCD) or a complementary metal-oxide semiconductor (CMOS), but is not limited thereby.

Under certain circumstances, it is not the surface of a specimen that is required to be inspected, but is the interior structure of the specimen that requires to be inspected. Thus, it is not the aforesaid reflection-type DIC microscope, but the transmission-type DIC microscope is required which is generally a symmetrically extension of the aforesaid reflection system. The following embodiment describe a transmission-type DIC microscope, in which different numbering will be used for avoiding confusion, but the functions of those components using the same names as those in the aforesaid reflection-type DIC microscope are not changed.

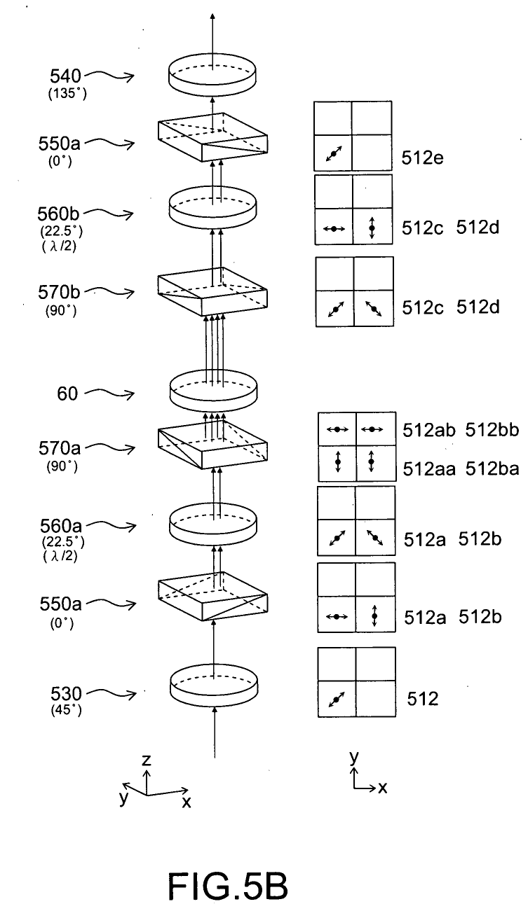

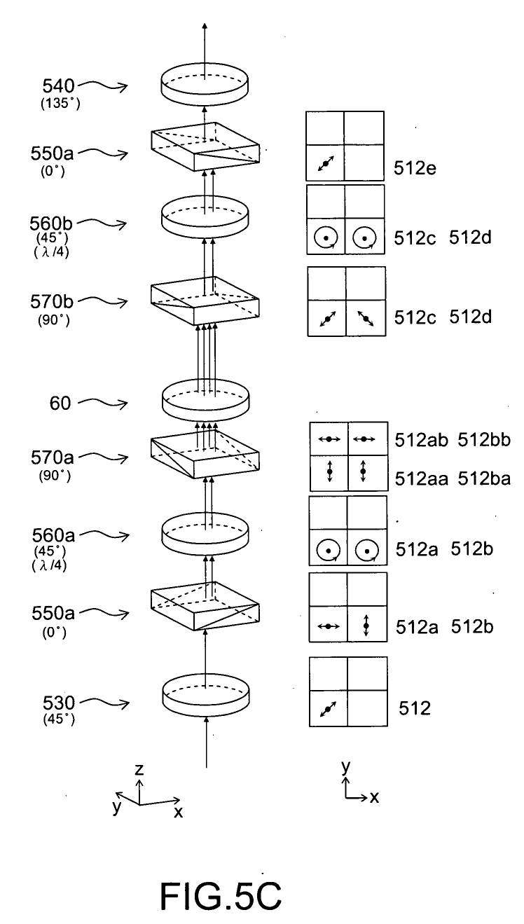

Please refer to FIG. 5A, which shows a differential interference contrast microscope according to another embodiment of the invention. The DIC microscope 500, being a transmission-type DIC microscope, is suitable of inspecting defects in the interior structure of a specimen 60 as the specimen is transparent for allowing light to enter and travel passing therethrough.

In this embodiment, a measurement area S is designed in the differential interference contrast microscope 500 for placing the specimen 60. For clarity, the description of the invention hereinafter will focus on the specimen 60, but for those skilled in the art that those descriptions relating to the specimen 60 can also apply to the measurement area S.

The DIC microscope 500 includes a light source 510, an image sensor 520, a first polarizer 530, a second polarizer 540, a first DIC prism 550a, a first wave plate 560a, a second DIC prism 570a, a third DIC prism 570b, a second wave plate 560a and a fourth DIC prism 50b, in which the light beam 512 emitted from the light source 510 travels passing the specimen 60 and then impinges the image sensor 520 as the first polarizer 530, the second polarizer 540, the first DIC prism 550a, the first wave plate 560a, the second DIC prism 570a, the third DIC prism 570b, the second wave plate 560b and the fourth DIC prism 550b are all located on the optical path of the light beam 512.

The first DIC prism 550a, the first wave plate 560a and the second DIC prism 570a are grouped as a first lens set. The first lens set and the first polarizer 530 are sequentially arranged between the light source 510 and the specimen 60 in a manner that the polarizer 530 is located near the light source 510 while enabling the first DIC prism 570a to be located at a position near the first polarizer 530. Similarly, the third DIC prism 570b, the second wave plate 560b and the fourth DIC prism 550b are grouped as a second lens set. The second lens set, being the symmetrical extension with respect to the first lens set, is sequentially arranged between the light source 510 and the specimen 60 with the second polarizer 540 in a manner that the second polarizer is located near the image sensor 520 while enabling the fourth DIC prism 550b to be located near the second polarizer 540.

Similar to the previous embodiment, by the cooperation of two mutually orthogonal DIC prisms and the use of the wave plate 470 for adjusting the polarization of the light beam, two interference information with respect to the two mutually orthogonal principle axes simultaneously can be obtained. Accordingly, as the first DIC prism 550a and the fourth DIC prism 550b are symmetrically disposed which is same to the second DIC prism 570a and the third DIC prism 570b, the principle axis relating to the first and the fourth DIC prisms 550a, 550b is disposed perpendicular to that relating to the third and the fourth DIC prisms 570a, 570b. In another word, if the principle axis of the first DIC prism 550a is defined to be the reference base, the included angle formed between the principle axis of the fourth DIC prism 550b and the that of the first DIC prism 550a is zero degree while the included angle formed between the principle axis relating to the third and the fourth DIC prisms 570a, 570b and that of the first DIC prism 550a is 90 degrees.

Accordingly, the light beam 512 will split into two rays 512a, 512b departing by a specific optical path difference after it travels passing the first DIC prism 550a. Then, after the two rays 512a, 512b travel passing the second DIC prism 570a, they are going to be split respectively into a pair of rays 512aa, 512ab, and another pair of rays 512ba, 512bb. Similarly, the optical paths of the two rays in the same pair are not the same, but are all being directed to the specimen 60. Thereafter, after the two rays 512aa, 512ab travel passing the third DIC prism 570b, the pair of rays 512aa, 512ab is converged into a ray 512c while the other pair of rays 512ba, 512bb is converged into another ray 512d after traveling passing the third DIC prism 570b. Thereby, the ray 512c will contain the interference information relating to the two rays 512aa, 512ab and the ray 512d will contain the interference information relating to the two rays 512ba, 512bb, i.e. the two rays 512c, 512d respectively contains interference data from the resolution axes of the second DIC prism 570a and the third DIC prism 570b.

Finally, the two rays 512c and 512d will be directed to travel passing the fourth DIC prism 550b where they are converged into a ray 512e which contains interference information of the two rays 512c, 512d. That is, the ray 512e contains interference data from the resolution axes of the first DIC prism 550a and the fourth DIC prism 550b. In another word, the ray 512e will contain not only the interference data from the resolution axis relating to the pair of the first and the fourth DIC prisms 550a, 550b, but also the interference data from the resolution axis relating to the second and the third DIC prisms 570a, 570b. Therefore, when the ray 512e impinges the image sensor 430, an image containing two interference information detected with respect to two mutually orthogonal resolution axes will be obtained simultaneously so that the specimen 60 can be inspected in a rapid manner.

Similar to the previous description, the principle axes of all the components in the DIC microscope 500 are defined with respect to the light beam 512 that they are not defined by any coordinate system as it is known to those skilled in the art. Thereby, in this embodiment of the invention, the optical axis of the light beam 512 should first be defined so as to be used as base for calibrating the principle axes of all the components in the DIC microscope 500. In this embodiment, the principle axis of the first DIC prism 550a is aligned with the optical axis of the light beam 512, that is, the included angle between the principle axis of the first DIC prism 550a and the optical axis of the light beam 512 is zero degree. Thus, the adjusting of the included angles between the principle axes of the other components and the optical axis of the light beam 512 is equivalent to the adjusting of the included angles between the principle axes of the other components and the principle axis of the first DIC prism 550a.

Thus, the included angles formed between the principle axis of the second DIC prism 570a and that of the third DIC prism 570b are all 90 degrees, and the principle axis of the fourth DIC prism 550b will be aligned exactly with the optical axis of the light beam 512. Moreover, in this embodiment, there is an included angle of 45 degrees being formed between the principle axis of the first polarizer 530 and the optical axis of the light beam 512 and another included angle of 135 degrees formed between the principle axis of the second polarizer 540 and the optical axis of the light beam 512, by which the first polarizer 530 and the second polarizer 540 are designed to function respectively as a polarizer and an analyzer.

In addition, the first wave plate 560a and the second wave plate 560b are used for adjusting the polarization of the light beam 412. In this embodiment, both the first and the second wave plates 560a, 560b are quarter-wave plates whose principle axes form an included angle of 45 degrees with the optical axis of the light beam 512. However, in another embodiment, the first and the second wave plate 560a, 560b can be a half-wave plate, so that their principle axes should form an included angle of 22.5 degrees with the optical axis of the light beam 512.

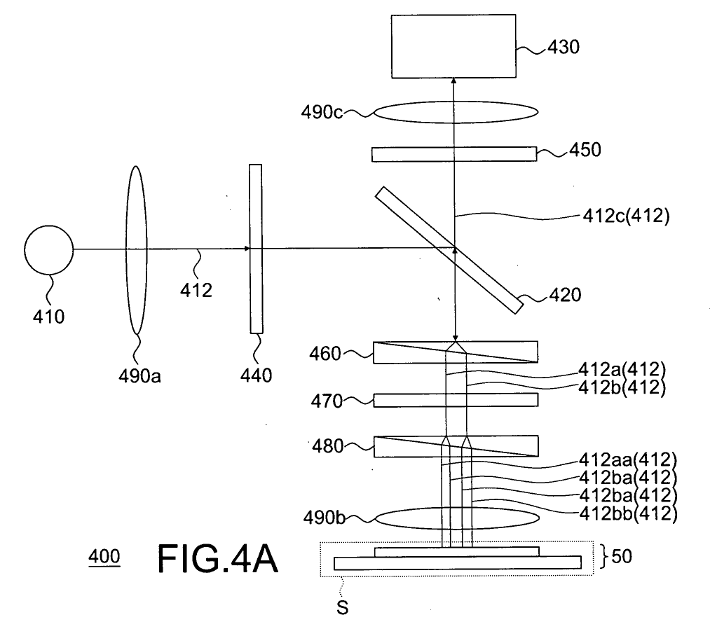

Please refer to FIG. 5B and FIG. 5C, which are schematic diagrams showing how the beam in FIG. 5A is polarized as it travels passing different components. It is noted that the FIG. 5B, the first wave plate 560a and the second wave plate 560b in FIG. 5B are both half-wave plates while the first wave plate 560a and the second wave plate 560b in FIG. 5C are both half-wave plates. Comparing the polarization of the light beam 512 by the different wave plates in FIG. 5B and FIG. 5C, the functionality of various wave plates can be clearly identified. Wherein, when a half-wave plate is used as the first wave plate 560a, the light beams 512a, 512b will be respectively polarized by 45 degrees and 135 degrees to impinge the second DIC prism 570a; and when a quarter-wave plate is used as the first wave plate 560a, the light beams 512a, 512b will be circularly polarized thereby to impinge the second DIC prism 570a which is similar to the quarter-wave plate shown in FIG. 3. Moreover, as the traveling of the light beams in this transmission-type DIC microscope is similar to the reflection-type DIC microscope shown in FIG. 4A, description relating to the traveling of the light beams in this transmission-type DIC microscope are known to those skilled in the art and thus will not be further described herein.

In the embodiment shown in FIG. 5A, for enhancing the collimation of light beam with respect to the focus accuracy, the DIC microscope 500 is further configured with a first lens 580a, a second lens 580b, a third lens 580c and a fourth lens 580d while locating those on the optical path of the light beam 512 in a manner that the first lens 580a is located between the light source 510 and the first polarizer 530, the second lens 580b is located between the specimen 60 and the second DIC prism 570a, the third lens 580c is located between the specimen 60 and the third DIC prism 570b, and the fourth lens 580d is located between the second polarizer 540 and the image sensor 520. It is noted that the configuration of the aforesaid lenses relating to their disposition and quantity is only for illustration and thus is not limited thereby.

To sum up, the DIC microscope of the invention regardless whether it is structured as a reflection system or as a transmission system, may capable of obtaining an image of a specimen in a measurement area in a single operation that contains two information detected with respect to two mutually orthogonal resolution axes simultaneously, so that it may complete an inspection in an automatic and rapid manner and thus the inspection efficiency is enhanced. As the one image containing two information detected with respect to two mutually orthogonal resolution axes can be obtained by the installation of one addition DIC prism or wave plate, the structure of the DIC microscope of the invention is comparatively simple.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A differential interference contrast (DIC) microscope, comprising:
a light source, for generating a light beam;
a beam splitter, for reflecting the light beam to a measurement area;
an image sensor, positioned at a position for receiving the light beam after the light beam being reflected from the measurement area and traveling passing through the beam splitter;
a first polarizer, disposed on the optical path of the light beam at a position between the light source and the beam splitter;
a second polarizer, disposed on the optical path of the light beam at a position between the beam splitter and the image sensor;
a first DIC prism, disposed on the optical path of the light beam at a position between the beam splitter and the measurement area;
a wave plate, disposed on the optical path of the light beam at a position between the first DIC prism and the measurement area; and
a second DIC prism, disposed on the optical path of the light beam at a position between the wave plate and the measurement area for enabling an included angle formed between the principal axis of the first DIC prism and the principal axis of the second DIC prism to be 90 degrees.

2. The DIC microscope of claim 1, wherein the wave plate is a quarter-wave plate.

3. The DIC microscope of claim 2, wherein there is an included angle of 45 degrees being formed between the principle axis of the first polarizer and the optical axis of the light beam while enabling another included angle of 135 degrees to be formed between the principle axis of the second polarizer and the optical axis of the light beam; and the same time that the principle axis of the first DIC prism is aligned exactly with the optical axis of the light beam while enabling an included angle of 90 degrees to be formed between the principle axis of the second DIC prism and the optical axis of the light beam, and enabling another included angle of 45 degrees to be formed between the principle axis of the quarter-wave plate and the optical axis of the light beam.

4. The DIC microscope of claim 1, wherein the wave plate is a half-wave plate.

5. The DIC microscope of claim 4, wherein there is an included angle of 45 degrees being formed between the principle axis of the first polarizer and the optical axis of the light beam while enabling another included angle of 135 degrees to be formed between the principle axis of the second polarizer and the optical axis of the light beam; and the same time that the principle axis of the first DIC prism is aligned exactly with the optical axis of the light beam while enabling an included angle of 90 degrees to be formed between the principle axis of the second DIC prism and the optical axis of the light beam, and enabling another included angle of 22.5 degrees to be formed between the principle axis of the half-wave plate and the optical axis of the light beam.

6. The DIC microscope of claim 1, further comprising:
a first lens, disposed on the optical path of the light beam at a position between the light source and the first polarizer.

7. The DIC microscope of claim 1, further comprising:
a second lens, disposed on the optical path of the light beam at a position between the measurement area and the second DIC prism.

8. The DIC microscope of claim 1, further comprising:
a third lens, disposed on the optical path of the light beam at a position between the second polarizer and the image sensor.

9. The DIC microscope of claim 1, wherein the image sensor is a charge coupled device (CCD).

10. A differential interference contrast (DIC) microscope, comprising:
a light source, for generating a light beam;
an image sensor, positioned at a position for receiving the light beam after the light beam traveling passing through a measurement area;
a first polarizer, disposed on the optical path of the light beam at a position between the light source and the measurement area;
a first DIC prism, disposed on the optical path of the light beam at a position between the first polarizer and the measurement area;
a first wave plate, disposed on the optical path of the light beam at a position between the first DIC prism and the measurement area;
a second DIC prism, disposed on the optical path of the light beam at a position between the first wave plate and the measurement area, for enabling an included angle formed between the principal axis of the first DIC prism and the principal axis of the second DIC prism to be 90 degrees;
a third DIC prism, disposed on the optical path of the light beam at a position between the measurement area and the image sensor, for aligning its principle axis with the principle axis of the second DIC prism;
a second wave plate, disposed on the optical path of the light beam at a position between the third DIC prism and the image sensor;
a fourth DIC prism, disposed on the optical path of the light beam at a position between the second wave plate and the image sensor, for aligning its principle axis with the principle axis of the first DIC prism; and
a second polarizer, a third DIC prism, disposed on the optical path of the light beam at a position between the fourth DIC prism and the image sensor.

11. The DIC microscope of claim 10, wherein both the first wave plate and the second wave plate are quarter-wave plates.

12. The DIC microscope of claim 11, wherein there is an included angle of 45 degrees being formed between the principle axis of the first polarizer and the optical axis of the light beam while enabling another included angle of 135 degrees to be formed between the principle axis of the second polarizer and the optical axis of the light beam; and the same time that the principle axis of the first DIC prism is aligned exactly with the optical axis of the light beam while enabling an included angle of 90 degrees to be formed between the principle axis of the second DIC prism and the optical axis of the light beam, and enabling the principle axis of the fourth DIC prism to be aligned exactly with the optical axis of the light beam, and enabling included angles of 45 degrees to be formed between the principle axis of the first quarter-wave plate and the optical axis of the light beam as well as between that of the second quarter-wave plate and the optical axis of the light beam.

13. The DIC microscope of claim 12, wherein both the first wave plate and the second wave plate are half-wave plates.

14. The DIC microscope of claim 13, wherein there is an included angle of 45 degrees being formed between the principle axis of the first polarizer and the optical axis of the light beam while enabling another included angle of 135 degrees to be formed between the principle axis of the second polarizer and the optical axis of the light beam; and the same time that the principle axis of the first DIC prism is aligned exactly with the optical axis of the light beam while enabling an included angle of 90 degrees to be formed between the principle axis of the second DIC prism and the optical axis of the light beam, and enabling the principle axis of the fourth DIC prism to be aligned exactly with the optical axis of the light beam, and enabling included angles of 22.5 degrees to be formed between the principle axis of the first quarter-wave plate and the optical axis of the light beam as well as between that of the second quarter-wave plate and the optical axis of the light beam.

15. The DIC microscope of claim 10, further comprising:
a first lens, disposed on the optical path of the light beam at a position between the light source and the first polarizer.

16. The DIC microscope of claim 10, further comprising:
a second lens, disposed on the optical path of the light beam at a position between the second DIC prism and the measurement area.

17. The DIC microscope of claim 10, further comprising:
a third lens, disposed on the optical path of the light beam at a position between the measurement area and the third DIC prism.

18. The DIC microscope of claim 10, further comprising:
a fourth lens, disposed on the optical path of the light beam at a position between the second polarizer and the image sensor.

19. The DIC microscope of claim 10, wherein the image sensor is a charge coupled device (CCD).
